(19) United States
(12) Patent Application Publication
(10) Pub. No.: US 2016/0342901 A1
(43) Pub. Date: Nov. 24, 2016

(54) METHOD OF STATE TRANSITION PREDICTION AND STATE IMPROVEMENT OF LIVEWARE, AND AN IMPLEMENTATION DEVICE OF THE METHOD

(71) Applicant: EETWO OPS Co., LTD., Seoul (KR)

(72) Inventors: Kyung Whan LEE, Seoul (KR); Keun LEE, Seoul (KR); Gee Yoen LEE, Seoul (KR)

(73) Assignee: EETWO OPS Co., LTD., Seoul (KR)

(21) Appl. No.: 15/017,076

(22) Filed: Feb. 5, 2016

(30) Foreign Application Priority Data
May 22, 2015 (KR) 10-2015-0071857

(51) Int. Cl. G06N 5/04; G06N 99/00

(52) U.S. Cl. CPC G06N 5/04; G06N 99/005

(57) ABSTRACT

A method of state transition prediction and state improvement of liveware including providing to a patient a GQM for diagnosing an arbitrary handicap symptom related to the liveware among human factors in xSHEL model, judging the state about the handicap symptom having occurred to the patient from response of the patient about the GQM, presenting a state transition where the state proceeds to next state to STG, transforming into a table by presenting each node of the STG as a spatial coordinate and STO data measuring a resilience level of the patient by using STG, designing a disturbance customized to liveware of the patient, applying this disturbance to the patient, estimating a resilience rate that the patient adapts to the disturbance, identifying an early alarm signal representing a threshold situation, and providing a training program for treating the progress of the state transition and recovery for individual cognitive availability.

### BACKGROUND

(a) Technical Field

The present disclosure relates to a method of state transition prediction and state improvement of liveware and an apparatus of state transition prediction and state improvement of liveware. In particular, it relates to a method and an apparatus which can provide a training program which can predict the state transition and a rapid variation point (catastrophe point) of a subject by a catastrophe model.

(b) Background Art

As a scheme of judging a state of the handicap about a subject and predicting the time of occurrence of the handicap, “A method of constructing a bigdata by using trivial trigger data of human element applicable to a dynamic device (Korea registered patent 1503804) (hereinafter referred to as registered patent)” has been suggested.

However, the above registered patent has its object at the prediction of the handicap. In addition, although the above registered patent discloses a construction of providing an animation contents for improving the handicap, how the contents is constructed is not described in detail.

### PRIOR ART DOCUMENT

### Patent Document

(Patent document 0001) Korea registered patent 1503804)

### SUMMARY OF THE DISCLOSURE

To solve the problems described above, an object of the present invention is to provide a method which can predict a state transition and occurrence of handicap and improve the current handicap state by tracing the state transition of the handicap observed on a subject, and an apparatus for embodying the method.

An apparatus for embodying state transition prediction and state improvement of liveware according to the present invention to accomplish the object described above comprises: an STTD construction and DB connection function section 1100 for providing to a patient a GQM (Goal Questionaire Metrics) for diagnosing an arbitrary handicap symptom related to the liveware among human elements in xSHEL model, for deriving keyword related to the handicap symptom having occurred to the patient from response of the patient about the GQM, for judging the state about the handicap symptom having occurred to the patient by the keyword, for presenting a state transition where the state proceeds to next state to a state transition graph (STG) having a plurality of nodes (each node corresponds to the state about the handicap symptom), for transforming into a table by presenting each node of the STG as a spatial coordinate and STO data which is an attribute with which the state transition proceeds, and for interfacing the spatial coordinate and the STO data with a DB device; a resilience level measurement section 1200 for measuring a resilience level of the patient by using the STO data; a disturbance design/introduction and resilience rate estimation function section 1300 for designing a disturbance customized to the liveware of the patient, for applying the designed disturbance to the patient, and for estimating a resilience rate with which the patient adapts to the disturbance; and an early alarm signal identification and training program providing function section 1400 for identifying an early alarm signal representing a threshold situation where the state transition of the patient rapidly changes to the handicap symptom, and for providing a training program for treating the progress of the state transition or a training program for reinforcing an adaptation power which can raise the resilience rate of the patient.

Here, the handicap symptom is “melancholy” or “lack of care” included in “mental element” among the “liveware” of the “xSHEL” model obtained by enlarging trivial trigger data of “SHEL” model.

In addition, the STTD construction and DB connection function section 1100 comprises: an STG construction module of ordered pairs 1110 embodying a graph presentation and table preparation function 1111 and a tracing function of state transition 1112; and a regulation construction module of state transition 1120 embodying an STO information process function 1122 and an interface function 1123 between STG and DB for constructing the regulation of state transition.

Furthermore, the resilience level measurement section 1200 comprises: a required time measurement module of state transition between two units 1210; a state transition analysis module 1220 embodying a GQM analysis function 1221 for verification by specialist and a required time estimation function up to the threshold situation 1222; a transition direction search/displacement measurement/quantities estimation module 1230; a required time measurement and confirmation module 1240 embodying a required time measurement function 1241, a stepwise variation level weight determination function 1242, and a required time conformation reference establishment function 1243; and a resilience measurement algorithm providing module 1250 for providing an algorithm for measuring the resilience of the patient based on the STO.

In addition, the disturbance design/introduction and resilience rate estimation function section 1300 comprises: a disturbance design module 1310 embodying an STO attribute adjustment function 1311 and a contents plan contents change function 1312; a disturbance design module by increase of variety of STO 1320 for designing the disturbance to be introduced to the patient; a disturbance design module increasing the variety of trap decreasing the resilience 1325; a disturbance introducing method establishment module 1330 for adjusting the introducing method, strength and size, number of times and hour, speed and displacement direction, quantities, etc. to introduce the designed disturbance to a specific node during the state transition process of the patient; a resilience rate estimation module 1340 embodying a disturbance introduction node, introducing method, disturbance size determination function 1341, a function of selection of adjustment parameter of disturbance introduction STO and measurement of reorganization ability of patient 1342, and a resilience rate estimation function 1343; and a resilience rate improvement and product analysis module 1350 embodying a node time centered improvement product analysis function 1344 and a improvement product analysis function 1345 by the comparison of state transition of node.

Furthermore, the early alarm signal identification and training program providing function section 1400 comprises: a spatial correlation estimation module of time series material 1410 embodying a relation analysis function of environment factor and state transition process of patient 1411, a time series spatial correlation estimation function connecting environment factor and state transition of patient 1412, an equilibrium state maintenance judgment function 1413, and a judgment function whether or not going to threshold situation 1414; a resilience rate comparison module of two units 1420 embodying a folding bifurcation signal observation function 1421; a disturbance introduction and early alarm signal identification module 1430 for identifying the early alarm signal according to the introducing of the disturbance; and a resilience rate raising training program providing module 1440 embodying a training program providing function for reorganization power improvement for improving the resilience and adaptation power of the patient 1441, a training program providing function for suppressing the noise in inducing the state transition to the separatix 1442, a training program providing function for eliminating the handicap factor 1443, and a meta cognition reinforcement training program providing function 1444.

A method of state transition prediction and state improvement of liveware according to another embodiment of the present invention to accomplish the object described above comprises: (1) a step of providing to a patient a GQM (Goal Questionaire Metrics) for diagnosing an arbitrary handicap symptom related to the liveware among human elements in xSHEL model, deriving keyword related to the handicap symptom having occurred to the patient from response of the patient about the GQM, and judging the state about the handicap symptom having occurred to the patient by the keyword; (2) a step of presenting a state transition where the state proceeds to next state to a state transition graph (STG) having a plurality of nodes (each node corresponds to the state about the handicap symptom), and transforming into a table by presenting each node of the STG as a spatial coordinate and STO data which is an attribute with which the state transition proceeds; (3) a step of measuring a resilience level of the patient by using the STO data; (4) a step of designing a disturbance customized to the liveware of the patient, applying the designed disturbance to the patient, and estimating a resilience rate with which the patient adapts to the disturbance; and (5) a step of identifying an early alarm signal representing a threshold situation where the state transition of the patient rapidly changes to the handicap symptom, and providing a training program for treating the progress of the state transition or a training program for reinforcing an adaptation power which can raise the resilience rate of the patient.

At this time, the step of (2) comprises: a step of constructing an STG of ordered pairs by a graph presentation and table preparation function 1111 and a tracing function of state transition 1112; and a step of constructing a regulation of state transition by an STO information process function 1122 and an interface function 1123 between STG and DB for constructing the regulation of state transition.

In addition, the step of (3) comprises: a step of measuring a required time of state transition between two units; a step of analyzing the state transition by a GQM analysis function 1221 for verification by specialist and a required time estimation function up to the threshold situation 1222; a step of searching a transition direction, measuring a displacement, and estimating quantities; a step of measuring and confirming the required time by a required time measurement function 1241, a stepwise variation level weight determination function 1242, and a required time conformation reference establishment function 1243; and a step of providing an algorithm for measuring the resilience of the patient based on the STO.

Furthermore, the step of (4) comprises: a step of designing the disturbance by an STO attribute adjustment function 1311 and a contents plan contents change function 1312; a step of designing the disturbance by increase of variety of STO to design the disturbance to be introduced to the patient; a step of designing the disturbance of increasing the variety of trap decreasing the resilience; a step of adjusting the introducing method, strength and size, number of times and hour, speed and displacement direction, quantities, etc. to introduce the designed disturbance to a specific node during the state transition process of the patient; a step of estimating the resilience rate by a disturbance introduction node, introducing method, disturbance size determination function 1341, a function of selection of adjustment parameter of disturbance introduction STO and measurement of reorganization ability of patient 1342, and a resilience rate estimation function 1343; and a step of analyzing the resilience rate improvement and product by a node time centered improvement product analysis function 1344 and a improvement product analysis function 1345 by the comparison of state transition of node.

In addition, the step of (5) comprises: a step of estimating the spatial correlation by a relation analysis function of environment factor and state transition process of patient 1411, a time series spatial correlation estimation function connecting environment factor and state transition of patient 1412, an equilibrium state maintenance judgment function 1413, and a judgment function whether or not going to threshold situation 1414; a step of comparing the resilience rate of two units by a folding bifurcation signal observation function 1421; a step of introducing the disturbance and identifying the early alarm signal for identifying the early alarm signal according to the introducing of the disturbance; and a step of providing a training program for raising the resilience rate of the patient by a training program providing function for reorganization power improvement for improving the resilience and adaptation power of the patient 1441, a training program providing function for suppressing the noise in inducing the state transition to the separatix 1442, a training program providing function for eliminating the handicap factor 1443, and a meta cognition reinforcement training program providing function 1444.

### Effect of the Present Invention

The present invention can provide a method which can predict a state transition and occurrence of handicap and improve the current handicap state by tracing the state transition of the handicap observed on a subject, and an apparatus for embodying the method.

In particular, following effects can be accomplished by applying Cat (catastrophe) model:
By using STG of the ordered pairs in the phase space, an algorithm can be efficiently designed which can comprehend the flow of state transition of the subject easily and precisely and make a table from the STG and store it to DB and retrieve it.
State transition rate between nodes can be estimated by applying differentiation, and precise state transition tracing device (STTD) can be developed and used by introducing the state transition object (STO).
By designing and introducing the disturbance, measuring the resilience level and estimating the resilience rate of the subject, a contents can be manufactured which can eliminate the handicap element which can hinder the raising of the resilience rate of the subject, and the training program using the contents can be developed.
STG and DB can be related in the phase space by introducing STO, the resilience level of the subject can be measured by using this DB, the resilience rate of the subject per the disturbance can be estimated precisely, and the early alarm signal about the threshold situation (rapid variation point) which can generate the handicap can be identified.
Development of the training program of the subject and the carer, evaluation of efficiency of the training, verification of reliability/availability of the training program can be performed logically and mathematically.

In addition, following effects can be obtained by introducing the state transition graph (STG):
The state transition of the subject can be presented by a coherent and systematic graph.
An algorithm which prepares a table mapped to STG and stores it to DB, and arbitrarily retrieves it can be designed and provided.
The state transition can be precisely traced by introducing a measuring technique of the displacement and quantities of STG.
The distance between the nodes (required time of state transition) can be estimated based on the elements of each STG.
The resilience rate of the subject can be compared and analyzed for each subject and state transition form based on each STG.

And, following effects can be obtained by introducing the STO:
The information process is possible according to ToC (Transfer of Control) for introducing the disturbance to the subject and controlling the state transition, AoC (Assumption of Control) for determining the premise for controlling STO, and the algorithm of LAM for providing logical procedure for exchanging STO data on STG.
The resilience of the subject can be measured and the resilience rate can be estimated by the information process.

### BRIEF DESCRIPTION OF THE DRAWINGS

FIG. 1a is a schematic block diagram of an apparatus for embodying a method of state transition prediction and state improvement of liveware (State Transition Tracing Device) (STTD) according to an embodiment of the present invention;

FIG. 1b is a drawing showing a detailed structure of a part of the STTD and a structure of a system operating it;

FIG. 1c is a drawing showing a detailed structure of remaining part of the STTD and a structure of a system operating it;

FIG. 2 is a drawing for explaining an embodying method of storing STO at the time of embodying the system shown in FIGS. 1b and 1c as a server-client structure;

FIG. 3 is a flow diagram of explaining a process of providing a training program based on state transition tracing as a method of state transition prediction and state improvement of liveware according to an embodiment of the present invention;

FIG. 4 is a flow diagram of explaining a process of providing a training program based on a resilience rate;

FIG. 5 is a block diagram for explaining target of the present invention based on Cat model;

FIG. 6 is a drawing showing an exemplary element STG as an example of STG

FIG. 7 is a drawing explaining a flow diagram for analyzing a process of the state transition by comparing and analyzing identity of patient and coherence of the state transition;

FIG. 8 is a flow diagram for explaining a process of identifying a threshold situation to identify an early alarm signal about handicap; and

FIG. 9 is a flow diagram for explaining a process of predicting a threshold situation in relation with the process of FIG. 8.

### DETAILED DESCRIPTION

Hereinafter, preferred embodiments of a method of state transition prediction and state improvement of liveware and an apparatus for embodying the method according to the present invention will be described. For reference, since the terminologies referring to each constituting element of the present invention are made exemplary by considering each function, the technical contents of the present invention should not be understood by predicting based on the terminologies and limiting the contents to the terminologies.

The present invention uses xSHEL (Extended SHEL) model which extends SHEL (Software, Hardware, Environment, Liveware) model of human factor and subdivides the Liveware item up to 4th end node.

By using such xSHEL, the present invention identifies a trivial trigger data in a liveware zone, models a liveware state transition apparatus which can present and analyze the process of the state transition of a patient using the data as center, and suggests a State Transition Tracing System) and its using method which can provide early diagnosis/prevention/treatment of attention focusing force lack/excess action, mild cognitive impairment, and dementia by applying a Cat (Catastrophe) model.

In addition, the present invention discovers a technology of handicap diagnosis and cause analysis by using the Cat model, and develops a training program including a multimedia content which can raise the resilience rate and adaptability by providing an early alarm signal about a handicap occurrence.

Furthermore, the present invention develops various GQM (Goal Questionnaire Metrics), that is, a mouth opening GQM, a diagnosis GQM and a verification GQM by using the Cat model, and develops a training program including a multimedia content for tracing the state transition of the patient, extracting a keyword related to the cause, and preventing and treating the handicap.

Here, GQM means a questionnaire which can measure a target attainment level of the diagnosis of the handicap, cause analysis, and the prevention and treatment.

In addition, the present invention recognized that the state transition process of the liveware varies according to the principle of relativity of Einstein, and introduced and presented a State Transition Graph (STG) of ordered pairs to describe such transition. Furthermore, the present invention introduce and describe a State Transition Object (STO) to discover from the state transition process of the liveware a state transition rule which conforms to the motion law of Newton.

Here, STG and STO are defined and modeled based on the Cat model. And these are operated by being linked to a DB by the state transition tracing device (STTD).

In the meantime, the state transition of the liveware may occur due to unspecified various causes. In addition, after the second indication after the first indication of the handicap phenomenon, acceleration can be given to the occurrence of the phenomenon or situation of symptoms. Therefore, when the motion law of Newton is applied here, the Cat model can be designed and used which can interpret an extra weight value, a displacement and an amount of displacement of STO.

Finally, the present invention develops a training program which traces the state transition about the trivial trigger data based on the Cat model and STG, observes the early alarm signal indicating the handicap predicted to occur, and delays the progression of the symptom (state) which is presently occurring.

That is, the present invention is a technology of manufacturing a fusion product (for example, the state transition tracing device or the training program) which can store to DB a required time information about the state transition estimated taking the liveware of the patient by using the STG of the ordered pairs and the Cat model, measure a resilience, estimate a resilience rate, observe the early alarm signal of the handicap, and diagnose/treat by using the stored information.

Hereinafter, the concepts of STG and STO and the related knowledge used in the present invention will be described.

1) STG (State Transition Graph)
STG presents the state transition process of the trivial trigger data about the liveware as the state transition graph of the ordered pairs. All trivial trigger data are composed as nodes of state transition in STG. Generated STG includes all states and edges of the handicap, and these states and edges correspond to the selected trivial trigger data.
The trivial trigger data are presented as STG by being systemized and analyzed based on the Cat model (Catastrophe Model). STG is transformed into a table and stored in DB.
STO is constructed based on the Cat model, and the state transition can be traced by using the constructed STO. Whereby, the early alarm signal related to a threshold situation (Catastrophe point, that is, a point where the handicap state occurs) presented from the liveware can be identified, and a training method can be constructed which raise the cause analysis of the threshold situation and the resilience of the liveware.
The state transition can be traced by using a characteristic of differentiation in a phase space composed of an action surface and a control plane, and whereby, a training method can be constructed which can measure the level of resilience of subject and raise the resilience rate.
The Cat model is a basic model which makes it possible to discover technologies about logical interpretation of the optimum of presentation technology by the STG of ordered pairs, the logic showing that the state transition conforms to the motion law of Newton, the definition of the phase space composed of the action surface and the control plane, a rapid variation point (Catastrophe point, point of threshold situation) which makes it possible to identify the symptom proceeding to the handicap and the early alarm signal suggesting the final handicap occurrence, a bifurcation interpreting the control plane, and STO-oriented ToC, AoC, LAM, etc.
STG can include entire STG, partial STG, cluster STG, and element STG. Hereinafter, “STGs” will be referred to include one or plurality of the above described STG.
The entire STG includes all state transition nodes.
The partial STG corresponds to one which is obtained by simply dividing any STG. Therefore, the partial STG can include the STG such STG itself, cluster STG, and element STG.
The cluster STG consists of STO having particular internal/external conditions about the state transition. The cluster STG is one obtained by specifying and grouping the action related to the handicap symptom of the patient (an insured person), cause of the action, and nodes which perform particular state transition about the destination node of the state transition.
A group of particular state transition is focused on one destination node, and the cluster STG is designed by analyzing and interpreting the STO of the nodes which perform the state transition.
The element STG consists of minimum number of closely related nodes which perform the state transition, in one node having a cause or result.
At the time of specifying units for interpreting a spatial coherence, the units are specified taking the characteristic of each node as a reference in each node composing the element STG or cluster STG. At this time, the state transition can be traced by specifying the entire STG into two or more units and comparing each unit.
The units are specified taking the coherence of state transition as a center in the phase space. However, sometimes, they can be specified taking the identity of the patient as a center in the space.
The unit can be defined by elements placed at near distance or elements giving influence to the state transition between them.
The unit can be the partial STG, cluster STG, or element STG.
The STGs consist of STO (State Transition Object) including attributes of state transition having the spatial coherence of particular state. The objects having the spatial coherence have more identical characteristic compared to other objects.
The state transition can be traced by measuring the spatial coherence on any STG. When inserting new nodes into the STGs, the node can be divided by a color in the STG. A path can be observed between STGs of the ordered pairs by searching the path between nodes on STG. The shortest path is used for identifying the early alarm signal.
When reviewing one node, the number of nodes connected as the cause of the node is referred to as “input path number” and the number of nodes connected as the result is referred to as “output path number”.
STGs can be transformed into a table having the trivial trigger data as items and can be used for tracing the state transition by being assembled in various ways.
Among the nodes N1, N2, . . . Nn on STG, when taking two adjacent nodes during the state transition as Ni−1 and Ni, the Ni−1 becomes the cause node of the state transition and the Ni becomes the destination node (or result node) of the state transition.
To explain the trace of the state transition, the nodes can be specified into an initial node and end node, a cause node and result node, a start node and destination node, and etc.
All STGs can have the element STG as a partial set. As an example, the state transition process from the cause node Ni−1 to the destination node Ni can be presented as four stages of initial symptom (Ni−1 or Ni−a1)⇄phenomenon (Ni−a2)⇄situation (Ni−a3)⇄handicap (Ni or Ni−a4).

2) STO (State Transition Object)

(1) Characteristic of STO
STO (State Transition Object) is an object for explaining the attribute of the trivial trigger data during the process of state transition on STG.
The nodes are particular situations of the state transition existing on STG of the ordered pairs and represent fixed positions. STO explains the attribute with which the state transition proceeds about the node and becomes an element for measuring, analyzing and evaluating each node. That is, the nodes can be said to be a physical element of STG and STO can be said to be a logical element of STG.
STO is updated to a most new information which can be obtained during life period of state transition of each node. To estimate the attribute related to the state transition about one node, the attribute of STO is used as a parameter.
If the attribute of STO is identified, the situation of the state transition can be explained/measured/analyzed/evaluated based on STO.
The required times of the state transition appear independently, and these times cannot be exchanged between the patients (an insured person).
The early alarm signal about the handicap occurrence can be observed by the analysis of STO, and the cause can be analyzed. Finally, the contents for improving the handicap can be manufactured.

(3) Constitutional Element of STO

\textcircled{1} STO identification code: patient identification code (id), STG position, administration code of DB (STO Cache code).

\textcircled{2} Presentation form: form which presents a value corresponding to the attribute of STO.

\textcircled{3} State Transition Information: information on direction, displacement, and quantities of transition.

The state transition information is information on derivation, emergency, disturbance, recovery, tractor, threshold transition, alternate stable state, etc. The tractor is a trajectory of inducing the state transition, the threshold transition is a state transition of the threshold situation which can approach the symptom and the handicap, the alternate stable state induces the patient to two or more stable states and pulls the patient to the threshold situation even when a small disturbance is given to the patient.

The threshold transition means that the patient proceeds to the threshold situation of melancholy or the threshold situation of uneasiness when, for example, a stress is given to the patient as a disturbance.

\textcircled{4} Early alarm signal information: this can be obtained through measurement and analysis of spatial coherence, spatial relation coefficient, variety, pattern, etc. in the phase space.

\textcircled{5} Resilience and resilience rate: this can be evaluated by referring to the design and introduction of the disturbance, resilience level, resilience rate, adjustment parameter of STO element, capability of reorganization of the patient confronting the change.

\textcircled{6} Position information on STG: these include spatial position information in the phase space about each of the entire STG, partial STG, cluster STG, element STG, etc. and position information on the graph.

\textcircled{7} Distance measurement information: these include the required time of state transition between the nodes, state kinds of result nodes, state kinds of cause nodes, spatial position in STG or phase space, etc.

\textcircled{8} Administration information on STO: these are information generated by processing the information such as trajectory coverage, AoC, ToC, LAM, etc.

3) Processing of Information on STO
All nodes except the cause node (start point of STG) and result node (end point of STG) become cross point node. The state transition is traced by taking each cross point node as a center.
To trace the state transition, the process of information on STO shall be performed according to the state transition control function of ToC, precondition for control of AoC, and logical procedure for data exchange of STO.

Here, ToC (Transfer of Control) is control function of disturbance introduction and state transition.

AoC (Assumption of Control) is precondition of control of STO.

LAM (Logical Acknowledgement) is a logical procedure for data exchange of STO on STG.

4) Method of Measuring the Resilience Level Based on STO
According to the procedure of ToC, the node for introducing the disturbance is selected, the method for introducing the disturbance is determined, and the size of disturbance to be introduced is determined. In addition, the introduction of disturbance is controlled by ToC based on the precondition of AoC and the procedure of LAM. The resilience consists of a measurement algorithm.
The algorithm for measurement of the resilience is as follows:

\textcircled{1} At the time of controlling STO, the condition of AoC shall be complied with.

\textcircled{2} The design of disturbance which exchanges the data of STO attribute shall be complied with.

\textcircled{3} A lot of parts among STO elements can be substituted with each other without large change.

5) Method of Measuring the Displacement and Quantities of Each Node of STG
Displacement: this is a difference between an i-th cross point node (or, start node) and destination node based on coordinates. In case where there are many paths going from the cross point node to the destination node, the displacement is measured by the minimum function fi. The displacement at this time is defined as the quantities. The quantities include a delay time at the nodes on the path.
Quantities: this is a required time for state transition from i-th cross point node to destination node. That is, this includes the time required for state transition between two nodes and the delay time at the intermediate nodes included in the path.
Minimum Function fi: this is an equation for measuring the quantity fi.

min(a, b): minimum value among two real numbers a and b.

<!--[endif]-->

In general, min ai=min(a1, min ai)

Here, for left side 1≦i≦n, and for right side 2≦i≦n

tij is the required time of the path from node 1 to node j, and fi becomes the longest required time among the paths proceeding from the node 1 to the node i.

About i=1, 2, . . . N (N is the destination node);

<!--[endif]-->

Here, j=1, 2, . . . , N. At this time, the meaning of max is the largest required time for all i from node i to node j.

6) State Transition System of Liveware: Basic Pattern of Cat Model
The system model of state transition about the patient takes the form as follows:

<!--[endif]-->

s: displacement or quantities by which the node is state transited within any preset time. It includes the delay time at the intermediate nodes. Therefore, s is a sum of the time delay of symptom and required time of state transition between nodes.

(x,y): means a spatial coordinates of system. That is, it is the coordinates on STGs. On the control plane of state transition, x value is the coordinate value of cause (that is, the coordinate value of cause node), and y value is coordinate value of handicap node. On the phase space, the value of control space becomes x, and the value of action surface becomes y.

a(x,y:t): this means an environmental element (including internal element and external element) of the patient promoting the state transition (s). For example, it can mean elements (melancholy, discomfort, stress, etc.) becoming causes of state transition, “varying both from node to node and in time”, and levels (four levels between Ni−1 ⇄Ni) of symptom appearing in particular node.

D: it means a diffusion coefficient, dispersion coefficient which raise the resilience rate by analyzing the state parameter and dispersing the handicap element. Whereby, the diffusion coefficient becomes a parameter which diffuses or evaporates the handicap level.

7) Prediction of Rapid Variation Situation by 6 Levels of the Forms of Disturbance and Handicap

6 levels of the form of handicap are \textcircled{1} diffusion and dispersion (evaporation) of the level of handicap, \textcircled{2} homeostasis (fast dynamic), \textcircled{3} slow dynamic, \textcircled{4} noise, \textcircled{5} singularity, and \textcircled{6} restoration.

If disturbance (for example, stress) is given to the patient, the homeostasis and the slow restoration process react to each other in the patient. This reaction has a characteristic of “diffusion”.

Fast dynamic or homeostasis of the patient intends to develop fast to other state. And, the slow dynamic intends to restore to a previous state.

Noise can occur in these two processes. In case the noise related to the action intends to pass through a separatix, the rapid variation situation (threshold situation, catastrophe situation) can occur.

8) Coherence of the State Transition and Identity of the Patient

Coherence of the state transition means a state in which transition element and process and destination of “initial symptom⇄phenomenon⇄situation⇄handicap” are equivalent or similarly varied.

Identity of the patient means a state in which original natures about the human element such as age, sex, family history, life level, economic level, social level, cognitive style, thinking style, etc. are equivalent or similarly varied.

These two points of view may be a reference of composing the unit of subjects for whom the resiliences are to be measured.

The present invention can obtain effects as follows by introducing Cat model, STG, STO, etc. to provide the structure and function as described above:

By using STG of the ordered pairs in the phase space, an algorithm can be efficiently designed which can comprehend the flow of state transition of the subject easily and precisely and make a table from the STG and store it to DB and retrieve it.

State transition rate between nodes composing STG can be estimated by applying differentiation, and precise state transition tracing device (STTD) can be developed and used by introducing the state transition object (STO).

By designing and introducing the disturbance, measuring the resilience level and estimating the resilience rate of the subject, a contents can be manufactured which can eliminate the handicap element which can hinder the raising of the resilience rate of the subject, and the training program using the contents can be developed.

STG and DB can be related in the phase space by introducing STO, the resilience level of the subject can be measured by using this DB, the resilience rate of the subject per the disturbance can be estimated precisely, and the early alarm signal about the threshold situation (rapid variation point) which can generate the handicap can be identified.

Development of the training program of the subject and the carer, evaluation of efficiency of the training, verification of reliability/availability of the training program can be performed logically and mathematically.

In addition, an algorithm which prepares a table mapped to STG and stores it to DB, and arbitrarily retrieves it can be designed and provided.

The state transition can be precisely traced by introducing a measuring technique of the displacement and quantities of STG.

The distance between the nodes (required time of state transition) can be estimated based on the elements of each STG.

The resilience rate of the subject can be compared and analyzed for each subject and state transition form based on each STG.

Furthermore, the information process is possible according to ToC (Transfer of Control) for introducing the disturbance to the subject and controlling the state transition, AoC (Assumption of Control) for determining the premise for controlling STO, and the algorithm of LAM for providing logical procedure for exchanging STO data on STG.

The resilience of the subject can be measured and the resilience rate can be estimated by the information process.

In continuation, a method of state transition prediction and state improvement of liveware and an apparatus for embodying the method will be described with reference to the accompanying drawings.

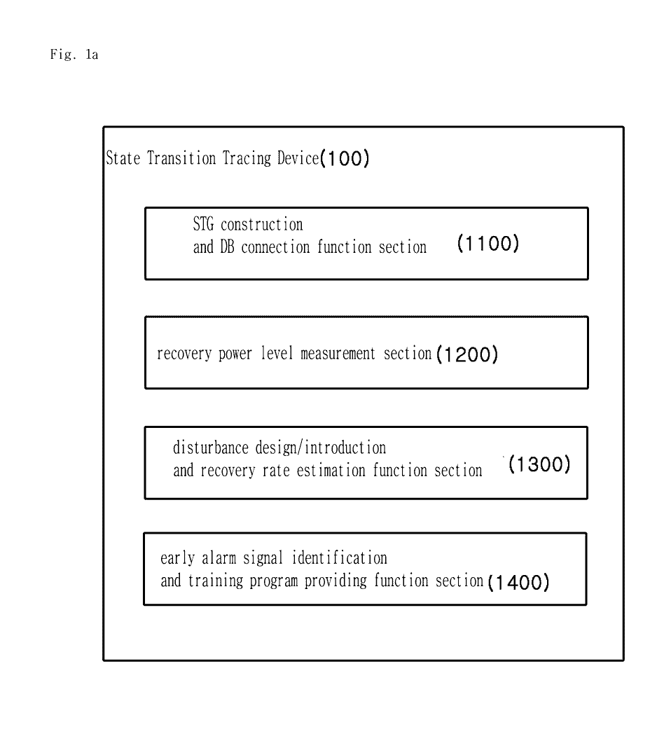

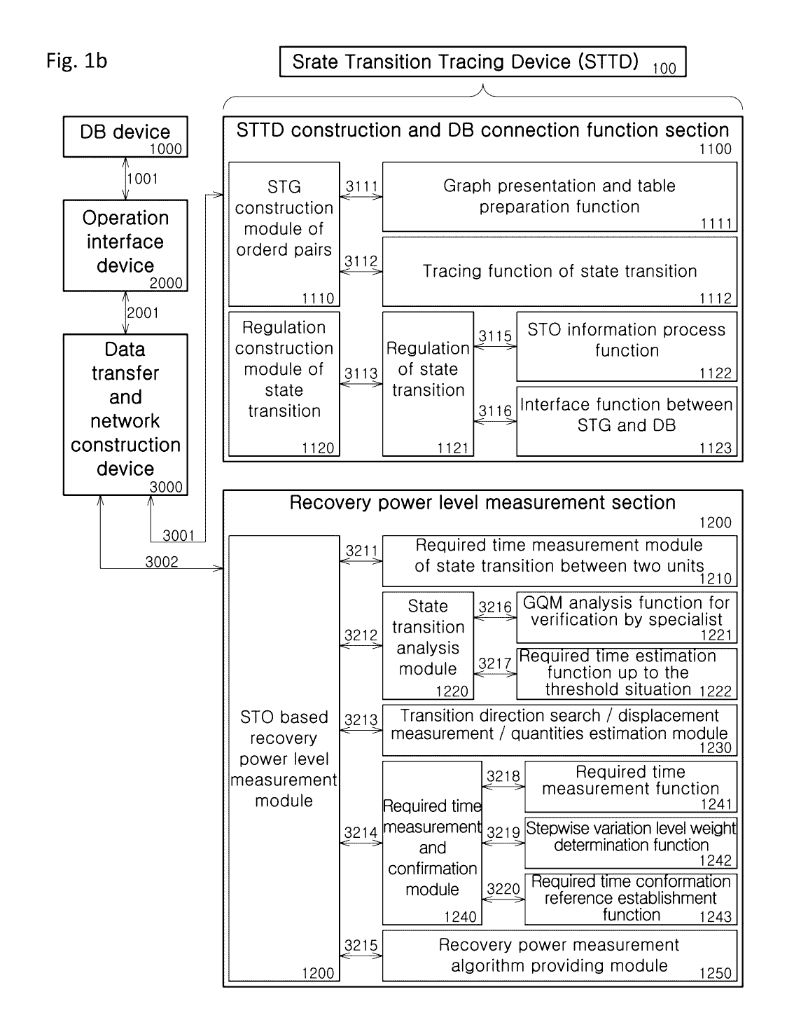

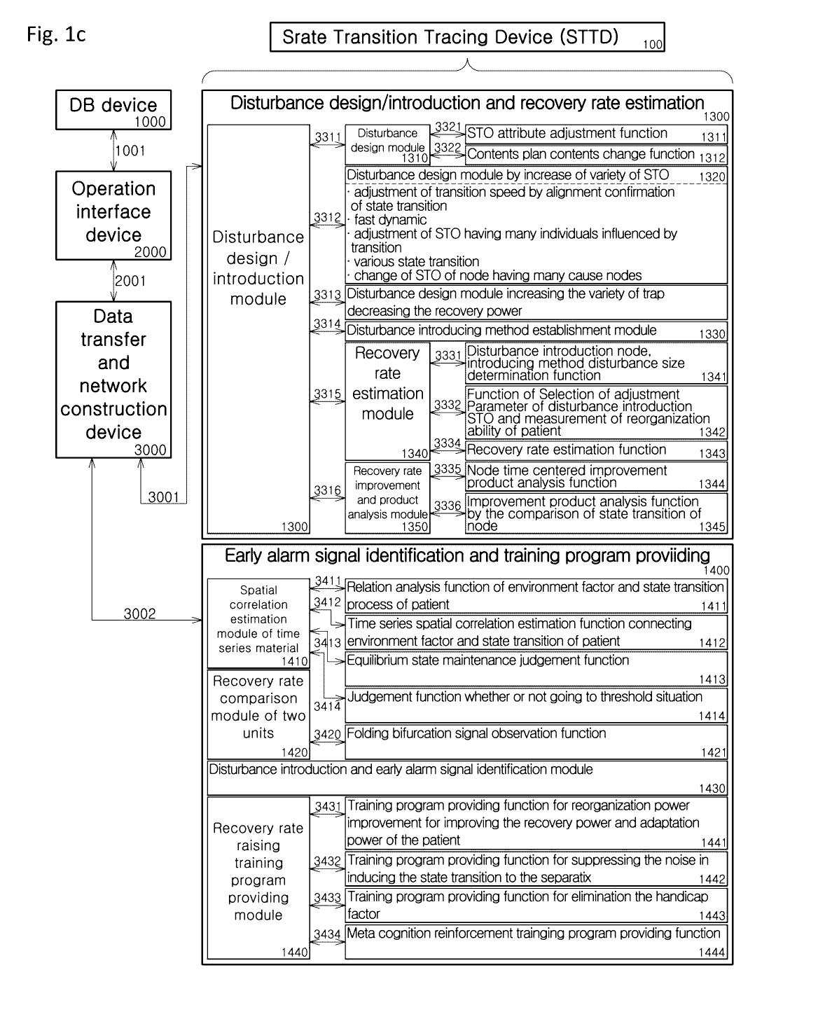

FIG. 1a is a schematic block diagram of an apparatus for embodying a method of state transition prediction and state improvement of liveware (State Transition Tracing Device) (STTD) according to an embodiment of the present invention. Referring to the drawings, the State Transition Tracing Device (STTD) 100 includes functions of early diagnosing, preventing and treating a concentration power lack excess action, mild cognitive impairment, and dementia by applying Cat model, and is composed by comprising an STTD construction and DB connection function section 1100, a resilience level measurement section 1200, a disturbance design/introduction and resilience rate estimation function section 1300, and an early alarm signal identification and training program providing function section 1400.

And, STTD 100 can be connected to DB device 1000 through a data transfer and network construction device 3000 and an operation interface device 2000.

The STTD construction and DB connection function section 1100 presents the state transition about the handicap symptom generated at the liveware as the state transition graph (STG), transforms STG into a table, and supports to prepare the table to interface with DB through an STO cache.

The resilience level measurement section 1200 embodies various functions of measuring the resilience level based on the state transition object (STO).

The disturbance design/introduction and resilience rate estimation function section 1300 embodies various functions of designing the disturbance customized to the liveware, introducing the designed disturbance to the state transition process of the patient, and estimating the resilience rate adaptable to the disturbance introduced to the patient.

The early alarm signal identification and training program providing function section 1400 embodies various functions of identifying the early alarm signal presenting the threshold situation where the state transition of the patient develops to the handicap state, and providing the training program for preventing and treating the handicap state or the training program about the adaptation power of raising the resilience rate of the patient.

The DB device 1000 includes various training programs, STG about particular patient, and the table obtained by transforming the STG, and is stored with a big data about the handicap occurrence, state transition and treatment obtained through a number of patients.

The data transfer and network construction device 3000 supports the data transfer with the DB device 1000 by connecting the STTD 100 to the network.

The operation interface device 2000 construct a network environment which can access and operate the information stored in the DB device 1000.

FIG. 1b is a drawing showing a detailed structure of a part of the STTD and a structure of a system operating it. The STTD construction and DB connection function section 1100 can comprise an STG construction module of ordered pairs 1110 and a regulation construction module of state transition 1120.

The STG construction module of ordered pairs 1110 provides a graph presentation and table preparation function 1111. In addition, it further provides a tracing function of state transition 1112.

The function 1111 presents the state transition process of the trivial trigger data of the liveware in the phase space as the STG of ordered pairs, and prepares a table based on the STG and make the state transition data to be stored in DB. STG is specified into an entire STG, partial STG, cluster STG, and element STG and graphs of respective STG can be prepared.

By the tracing function of state transition 1112, the state transition can be traced on STG by using STO based on Cat model, and the information about direction, displacement and quantities of the transition can be estimated.

The regulation construction module of state transition 1120 provides an STO information process function 1122 and an interface function 1123 between STG and DB to construct the regulation of state transition.

The function 1122 performs the control function of ToC, the premise for control of AoC, and the logical procedure of data exchange by LAM.

The function 1123 embodies the interface between STTD and DB by administrating the STO cache. The STO cache can be constructed at a server of DB device or at a client thereof. STO administrator of DB device is embodied to wrap the interface of DB device to store the STO cache which is a continuous object.

The resilience level measurement section 1200 may comprise an STO based resilience level measurement module 1200′, a required time measurement module of state transition between two units 1210, a state transition analysis module 1220, a transition direction search/displacement measurement/quantities estimation module 1230, a required time measurement and confirmation module 1240, and a resilience measurement algorithm providing module 1250.

The required time measurement module of state transition between two units 1210 measures the resilience level based on STP by estimating the required time for the transition between the state transition elements of two arbitrary units and comparing them. Each unit is a subordinate group and can be specified taking the coherence of state transition in each space of STGs as a reference or taking the identity of the patient (insured person) if necessary.

The state transition analysis module 1220 measures the resilience level based on STO through the state transition analysis of analyzing the response contents about GQM (Goal Questionnaire Metrics) for verification by specialist and of estimating the required time up to the threshold situation. The state transition analysis module 1220 can comprise a GQM analysis function 1221 for verification by specialist and a required time estimation function up to the threshold situation 1222.

The function 1221 can provide to the patient the GQM for verification which can analyze the state transition situation of the patient, and can analyze the diagnosis state and the cause for treatment by deriving the keyword representing the symptom from the response contents. The keywords can be used to manufacture the multimedia contents for treatment or to select the manufactured contents. The GQM for verification may be constructed to check the recovery level from the response of the patient and analyze (Treatment compliance) the treatment effect.

The function 1222 measures the distance in time (required time of state transition between nodes) in the case where the state transition process is “very near to” the threshold situation or “a little far from” the threshold situation by GQM for verification.

The transition direction search/displacement measurement/quantities estimation module 1230, by being based on STO, searches the direction of transition, measures the displacement, performs the information process function of estimating the quantities, and performs the function of interfacing each result to measure the resilience level of the liveware. That is, the transition information is presented as a threshold transition approaching order, a state transition order, and a time delay of state, and its direction is measured in a direction of transition from an arbitrary node (initial node, start node, or cause node) to other node (end node, destination node, or result node), and its displacement and quantities are measured by the amount of time required for the process of state transition. The displacement and quantities of the state transition process combine and add the number of input paths and output paths taking Ni as a center, and the combination ratio can be determined based on Cat model or statistically according to the characteristic of state transition.

The required time measurement and confirmation module 1240 can measure the required time between nodes, determine the weight of stepwise variation level, and establish the reference for confirmation of required time to measure the STO based resilience level. The required time measurement and confirmation module 1240 embodies a required time measurement function 1241, a stepwise variation level weight determination function 1242, and a required time conformation reference establishment function 1243.

In the required time measurement function 1241, when comparing the required time between two groups, measurement and discrimination of the required time of state transition between nodes belonging to each group can follow the following reference. That is, the state transition speed of two groups of large spatial coherence increases according to motion law of Newton (that is, law of acceleration) (that is, the required time is reduced). In addition, since the state transited STOs exist in the space of state transition, the resilience characteristic of the group can be measured and the resilience rate can be estimated by analyzing the spatial correlation. At this time, the required time for transition on STG can be measured by the types and spatial positions of the cause node (or initial node, start node) and the result node (or end node, destination node) and by the influence and effect of the state transition of each node.

The function 1242 determines the stepwise level for checking the transition level of STO attribute and determines each stepwise weight. Here, each weight is a ratio determined for each measurement reference.

The function 1243 performs two procedures of (a) judging whether the comparatively near state transition node has the spatial coherence, and (b) judging the proximity to the handicap node (threshold situation) in case of having difficulty in judging by similar STO. The distance measurement between nodes is measured by the time of transition between nodes. The measurement objects of the required time are subordinate group of STG and can be selected from the units specified by taking the coherence of state transition in the space of STG as a center or specified according to the identity of the patient.

The resilience measurement algorithm providing module 1250 provides an algorithm for measuring the resilience of the patient based on STO. By the algorithm, by referring to ToC procedure, the node into which the disturbance is introduced, the method of introducing disturbance, and the size of disturbance to be introduced are determined. The disturbance is designed based on the premise of AoC and the procedure of LAM. The disturbance to be introduced is controlled by ToC, and the resilience is measured and the resilience rate is estimated according to the above described algorithm.

FIG. 1c is a drawing showing a detailed structure of remaining part of the STTD and a structure of a system operating it. The disturbance design/introduction and resilience rate estimation function section 1300 may comprise a disturbance design/introduction module 1300′, a disturbance design module 1310, a disturbance design module by increase of variety of STO 1320, a disturbance design module increasing the variety of trap decreasing the resilience 1325, a disturbance introducing method establishment module 1330, a resilience rate estimation module 1340, and a resilience rate improvement and product analysis module 1350.

The disturbance design/introduction module 1300′ can design the disturbance by being connected to the data transfer and network construction device 3000 and referring to the information stored in the DB device 1000, apply the designed disturbance to the patient, and estimate the resilience rate of the patient about the disturbance.

Here, the resilience rate means the speed and time of recovery from the disturbance the patient experiences.

To estimate the resilience rate, the disturbance appropriate to the patient should be designed, and the method appropriate for introducing the designed disturbance. In the meantime, the disturbance introduced on STG of the patient can be used for (a) comprehending the level of handicap form, (b) deriving the factor adversely effecting the resilience rate by measuring the diffusion coefficient, and manufacturing the train program (for example, multimedia contents) which can improve the adaptability of the patient.

The disturbance design module 1310 adjusts the STO attribute to perform the function of designing the disturbance and introducing it, and adjusts the plan contents of the multimedia contents used in introducing the disturbance. The disturbance design module 1310 comprises an STO attribute adjustment function 1311 and a contents plan contents change function 1312.

The function 1311 can design the disturbance by changing/adjusting a part or entire of the STO attribute and by exchanging with the attribute of other node.

The function 1312 can design the disturbance appropriate to the patient by changing the multimedia contents plan contents based on the adjusted STO. The change of the plan contents can include the change of scenario within identical category of multimedia contents, the situation adjustment by virtual reality (VR) and augmented reality (AR), the change of sound/intonation/speed/tone of characters.

The disturbance design module by increase of variety of STO 1320 can design the disturbance to be introduced and provide it to the data transfer and network construction device 3000, the operation interface device 2000 and the DB device 1000. The disturbance design module 1320 designs the disturbance taking the following attribute as a center. By this, the variety based on STO is increased.
By identifying alignment of state transition, the progress speed of state transition is adjusted: if the transition state is not aligned but there is a particular change in a patch which is specified as cluster STG or element STG (for example, unspecified change in the progress speed, etc.), it becomes an alarm signal of the transition.
The disturbance is adjusted based on the fast dynamic (or homeostasis).
STO having a large number of individuals which are influenced by the state transition is adjusted.
The disturbance is adjusted according to the variety of the state transition.
STO of nodes having a lot of cause nodes are changed.

The disturbance design module increasing the variety of trap decreasing the resilience 1325 designs the disturbance so as to increase the variety about the factors such as the traps about the liveware, that is, hasty conclusion, tunnel view, enlargement and contraction, personalization, externalization, excessive generalization, reading one's mind, and emotional reasoning, etc.

The disturbance introducing method establishment module 1330 stores to DB device 1000 or retrieves from DB device 1000 the data for adjusting the introducing method, strength and size, number of times and hour, speed and displacement direction, quantities, etc. to introduce the designed disturbance to a specific node during the state transition process of the patient. In addition, the patient introduced with the disturbance stores by himself the information about the state to which the patient is adapted, and retrieves it from DB device 1000. The retrieved information can be provided to the devices to be used.

The resilience rate estimation module 1340 stores information obtained by estimating the resilience rate after introducing the disturbance to the patient, retrieves it from DB device 1000, and provides interface with the device to be used. This resilience rate estimation module 1340 can embody a disturbance introduction node, introducing method, disturbance size determination function 1341, a function of selection of adjustment parameter of disturbance introduction STO and measurement of reorganization ability of patient 1342, and a resilience rate estimation function 1343.

If the environment condition about the liveware of the patient is raised by introducing the disturbance, the transition occurs at some point of time t. That is, when the disturbance is introduced until the total amount of a plurality of STOs and their attribute elements are abruptly changed and the disturbance is again reduced, the phenomenon that the total amount is abruptly lowered at time t does not occur, but “hysteresis phenomenon” that the total amount is lowered at the disturbance lower than that occurs. The environmental condition is determined by the adjustment parameter value of STO. On the element STG transited from Nk node to Nk+1 node, the size of shake appearing at the state of the patient is determined by introducing the disturbance at Nk node time and referring to the result at the state transited to Nk+1. And, the displacement and quantities are measured by including the number (number of diffused nodes) passed at Nk.

In addition, the introducing of the disturbance can be performed by correlating the identity of the patient about the liveware and the coherence of the internal and external condition of state transition and at the same time according to following references and procedures:
The strength and size of the disturbance is designed: the strength and size can be determined by matching the keywords which can measure the resilience and the STO element.
The number of times, time, and speed with which the disturbance is introduced are adjusted.
The introduction is carried out by referring to the displacement, direction, and quantities of state transition.
The introduction is adjusted by analyzing the absorption power and adaptation power which react after the patient received the disturbance.

The resilience rate observed from the patient by the disturbance thus introduced can be estimated by the STO information process algorithm.

The node to which the disturbance is to be introduced, the method of introducing the disturbance and the size of the disturbance to be introduced can be determined according to control of state transition for STO information process ToC, premise of control AoC, and logical procedure of STO information process.

The measurement of the resilience and the estimation of the resilience rate can be performed by referring to the design and introduction of the disturbance, the adjustment parameter of STO element, and the reorganization ability of the patient during corresponding to the variation.

The resilience rate can be estimated according to the type of patient and environment, the type of contents, and the type of disturbance.

The resilience rate improvement and product analysis module 1350 supports the resilience rate improvement for the purpose of treatment of the patient, and the interface with the device to be used by storing and retrieving the information obtained by analyzing the product. The resilience rate improvement and product analysis module 1350 can perform a node time centered improvement product analysis function 1344 and a improvement product analysis function 1345 by the comparison of state transition of node.

The resilience rate can be estimated by stepwise specifying the detailed items of the resilience rate improvement. Furthermore, the treatment compliance for analyzing the treatment effect by evaluating the improvement effect can be performed. In addition, the treatment effect can be measured and its efficiency can be analyzed by referring to the cost, improvement time, and the content of treatment compliance.

The early alarm signal identification and training program providing function section 1400 makes it possible to develop an appropriate training program by identifying the early alarm signal of handicap and supporting its cause analysis. At this time, the early alarm signal is identified by estimating a spatial correlation about time series material. The function section 1400 may comprise a spatial correlation estimation module of time series material 1410, a resilience rate comparison module of two units 1420, a disturbance introduction and early alarm signal identification module 1430, and a resilience rate raising training program providing module 1440.

The spatial correlation estimation module of time series material 1410 provides a relation analysis function of environment factor and state transition process of patient 1411, a time series spatial correlation estimation function connecting environment factor and state transition of patient 1412, an equilibrium state maintenance judgment function 1413, and a judgment function whether or not going to threshold situation 1414.

The function 1411 provides an interface with a device to be used by storing and retrieving the analysis data of relation of the identity related to the environment factor of the patient related to human factor and the transition process related to the coherence of state transition. Here, to analyze the relation between the environment factor related to the liveware of the patient and the state transition process, the spatial correlation of the time series material can be estimated.

The function 1412 provides an interface with a device to be used by storing and retrieving the spatial correlation of the time series material estimated by relating the identity of the patient and the coherence of state transition. Here, the spatial correlation can be estimated by comparing two time series materials connected in relation to the environment elements such as the age, sex, family history, life type, economic level, social level, cognitive style and thinking style, etc. of the patient and the coherence of the state transition about “initial symptom→phenomenon→situation→handicap”.

The higher the spatial correlation, the surer the signal becomes, and the dynamic variation of STGs maintains the equilibrium state by the counteraction rather than the diffusion. To the contrary, the lower the spatial correlation, the more uncertain the signal becomes, and even if a small disturbance is given by causing the contraction of the traction zone, it pushes the patient to the stable state so as to make it difficult to return to the original equilibrium state.

The function 1413 judges whether the state transition of the patient maintains the equilibrium state. The function 1414 judges whether the state transition of the patient goes to the threshold situation.

The resilience rate comparison module of two units 1420 provides an interface with a device to be used by identifying the signal which proceeds to the folding bifurcation and by storing and retrieving the identified information. The resilience rate comparison module of two units 1420 provides a folding bifurcation signal observation function 1421.

The function 1421 identifies the early alarm signal by comparing the resilience rate of two units. The two units can be determined by taking the nodes or STGs as the subjects.

In the meantime, if the highest order of state transition (destination node of STGs) exists near the folding bifurcation point, it can be judged to be the early alarm signal.

The bifurcation point is the threshold point where the threshold situation (catastrophe) can occur even if the adjustment parameter of the patient is varied only small.

The folding bifurcation is a state transition where two threshold situations approach while being folded in the form of “S”.

In case where the highest order of state transition exists a little far from the folding bifurcation point, it is difficult to be judged to be the early alarm signal.

The disturbance introduction and early alarm signal identification module 1430 provides an interface with a device to be used by identifying the early alarm signal according to the introduction of the disturbance and by storing and retrieving the identified information.

The increase of the variety according to the introduction of the disturbance is confirmed, and if the increase amount is large, it is identified as the early alarm signal. The increase of the variety is searched from the variety of state transition of the patient due to the disturbance or noise, steep variation, rapid transition of time, variety of state transition kinds (types), number of the objects giving influence to the state transition, factor lowering the resilience rate of the patient (for example, obtained by referring to the diffusion coefficient), etc. in relation to the designed disturbance.

The resilience rate raising training program providing module 1440 may comprise a training program providing function for reorganization power improvement for improving the resilience and adaptation power of the patient 1441 after identifying the early alarm signal and analyzing its cause, a training program providing function for suppressing the noise in inducing the state transition to the separatix 1442, a training program providing function for eliminating the handicap factor 1443, and a meta cognition reinforcement training program providing function 1444.

The function 1441 provides the information necessary for developing the training program for reorganization power improvement for improving the adaptation power of the patient.

The training for raising the resilience can be performed by manufacturing the multimedia contents for raising the reorganization power of the patient and providing it, and can be performed in parallel with the method of measuring the resilience rate product of the patient by preparing the GQM for verification.

The function 1442 provides the information necessary for developing the training program for preventing the noise generated during the introduction of disturbance from inducing the state transition to the separatix. By providing the training program for improving the adaptation power for counteracting the disturbance, the noise caused around the patient is prevented from approaching the separatix, that is, the inducing of the state transition to the separatix can be suppressed.

The training program can be provided to the patient for reinforcing the adaptation power of absorbing and reorganizing the shake so that the patient can maintain identical function, structure, identity, and feedback while the patient counteracts the variation.

The function 1443 provides the information necessary for developing the training program for eliminating the handicap factor generated according to the introduction of the disturbance. The training program is developed for estimating the constant coefficient (that is, diffusion coefficient or dispersion coefficient) for eliminating the factor of lowering the resilience rate and eliminating the factor of lowering the resilience rate of the patient (that is, the handicap factor), by measuring the resilience, resilience rate, adaptation power, reorganization ability of patient environment.

The function 1444 supports the training program for reinforcing the cognition ability through the situation cognition reinforcing program which can adjust six levels of the handicap types, and for arriving at the improvement target of the resilience rate.

The six levels of the handicap types indicate the diffusion and evaporation of the handicap level, homeostasis (fast dynamics), slow dynamics, noise, singularity and restoration. The training program manufactured for reinforcing the cognition ability through the meta cognition reinforcing training for adjusting these levels and for arriving at the improvement target of the resilience rate.

FIG. 2 is a drawing for explaining an embodying method of storing STO at the time of embodying the system shown in FIGS. 1b and 1c as a server-client structure.

The server can include the DB device 1000 or be connected thereto.

A page cache is a cache about the information to be presented visually at the client.

The client traces the state transition about the patient.

The STO cache is a storage device which has the cache installed at the server or client, and is constructed to interface with the DB device 1000. The STO cache can be constructed at the server side or the client side.

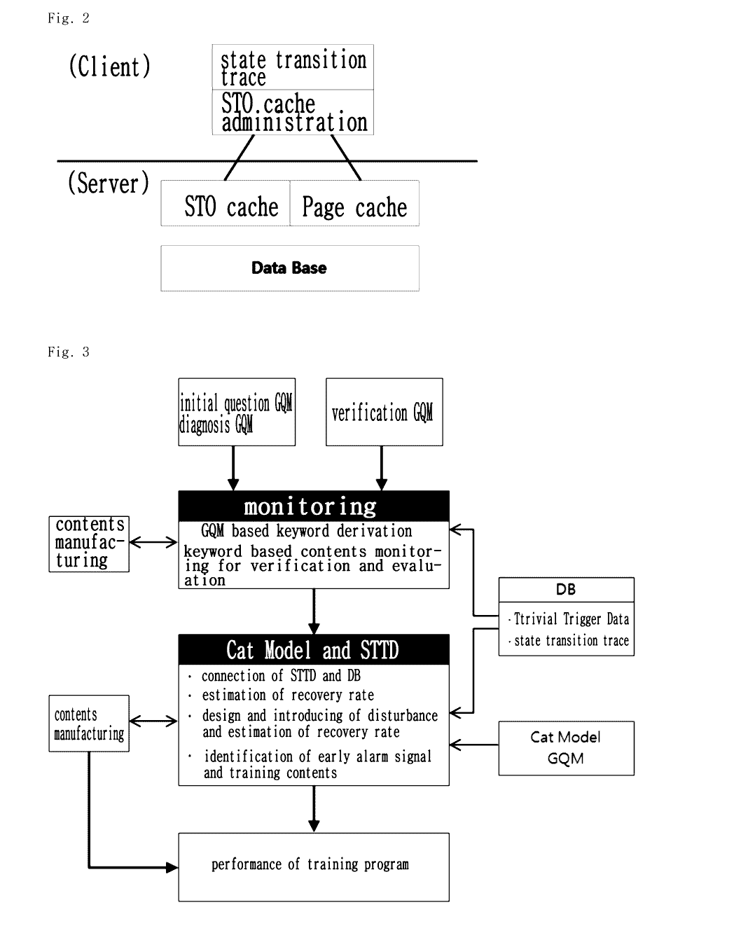

FIG. 3 is a flow diagram of explaining a process of providing a training program based on state transition tracing as a method of state transition prediction and state improvement of liveware according to an embodiment of the present invention. The training program based on the state transition trace and the multimedia contents is manufactured from the GQM information obtained through the questionnaire and the test paper. The keywords are derived from the response contents about the GQM, and the contents are manufactured based on the derived keywords. The training program is developed so as to perform the function of STTD based on the manufactured contents.

First, to judge the handicap state of the patient, various GQMs are provided and the responses to them are obtained. The GQMs can include a first question GQM which opens the mouth so that the patient can comfortably tell his mental state and a diagnosis GQM including the keywords for diagnosing the patient in fact. Furthermore, verification GQM for verifying the diagnosed state after the diagnosis of the patient can be further provided.

The present state of the patient is monitored by using these GQMs. That is, an optimum contents can be provided by deriving the keywords representing the state of the patient based on the GQM, selecting the contents to be provided to the patient based on the derived keywords, providing the selected contents to the patient, monitoring the state transition of the patient, and evaluating the effect of the contents.

Ones that are used at this time are the trivial trigger data described in the background art described above and the state transition tracing technology. The information about the state diagnosis obtained by the various GQM response contents and the keywords can be stored and administrated and used at the STTD 100 later.

In the meantime, the training program by the STTD can be provided to suit the level of handicap or for a customized learning to a group of the patients specified according to the attribute of STO. This is the core element of the present invention.

First, the state transition tracing device (STTD) 100 having the construction described above is prepared, and a mutual network is constructed to interlock the STTD 100 with the DB device 1000.

In continuation, based on the symptom of the patient obtained based on the above described GQM, the Cat model is designed and the state transition of the patient is traced. The trace of the state transition can be provided by estimating the resilience, designing and introducing the disturbance, estimating the resilience rate of the patient about the introduced disturbance, identifying the early alarm signal based on the estimated resilience rate, and constructing the training program appropriate to the patient.

Each procedure can be understood through the description of the constituting sections corresponding to the STTD 100.

Here, the training program can be simulated by using a method of introducing the optimum contents to a virtual model of the patient and thereafter observing the result (virtual treatment). A variety of virtual treatments can be performed by a variety of training programs, and the most preferable treatment effect can be anticipated by actually applying the virtual treatment method which exhibits the optimum result.

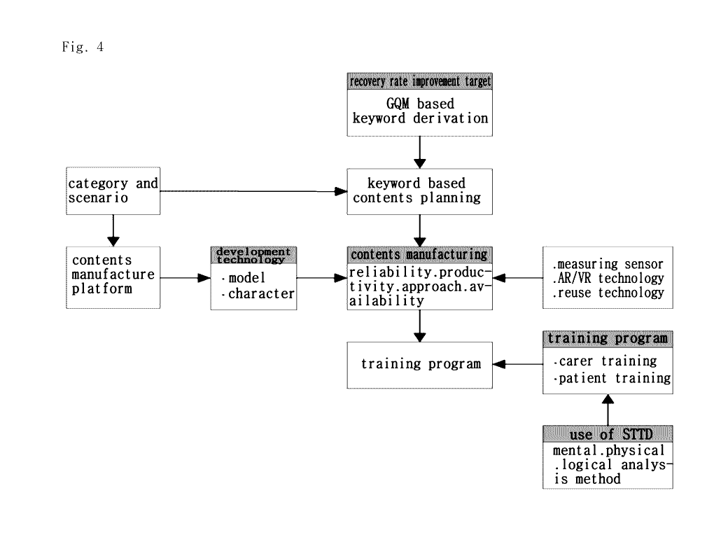

FIG. 4 is a flow diagram of explaining a process of providing a training program based on a resilience rate. The information on the resilience rate is obtained by introducing an arbitrary disturbance to the patient and analyzing the situation of the patient varying according thereto. The obtained information can be used to manufacture the multimedia contents for improving the state of the patient, and the multimedia contents thus manufactured can be a part of the training program for treating the patient.

The keywords about the handicap and state of the patient can be derived based on the various GQMs applied to the patient. The contents can be planned by using the category and scenario appropriate to the patient based on the keywords. The contents can include the multimedia contents including an arbitrary model and character. In addition, the contents shall be provided with various sensor technologies for measuring the state of the patient and the state of surrounding environment state, the augmented reality/virtual reality technologies, and the reuse technologies having the universality so as to use the contents to other symptoms too. Furthermore, these contents shall have the reliability, productivity, approachability and usability.

The multimedia contents can be a part of the training program. The training program can be specified into that for training the patient and that for training the carer. In constructing these training programs, the mental, physical and logical interpretation methods using the STTD 100 can be used.

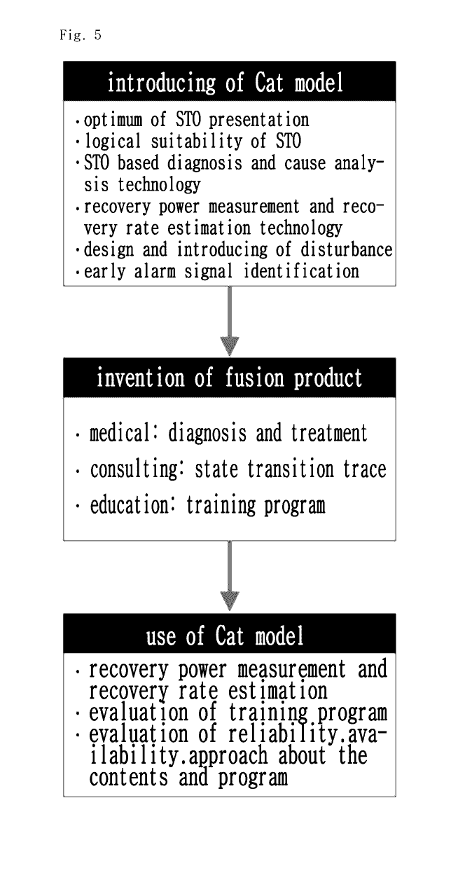

FIG. 5 is a block diagram for explaining target of the method of state transition prediction and state improvement of liveware according to the present invention based on the Cat model and of the apparatus embodying the method.

The present invention includes a scheme of using the Cat model by developing a fusion product for treating the handicap by introducing the Cat model and applying the fusion product to the patient.

That is, a medical product having the most suitability of the STG presentation analyzed by using the Cat model and the logical suitability of STO, performing the diagnosis based on STO and analysis of cause and adjustment and control of the state transition, and measurement of the resilience and estimation of the resilience rate, and for diagnosing and treating the handicap of the patient by introducing the technology of software engineering thereto, and a consulting product about the state transition tracing, and an educational product for diagnosis and treatment are manufactured. And, the reliability, usability and approachability about the training program can be evaluated.

FIG. 6 is a drawing showing an exemplary element STG as an example of STG. The STG which presents the state transition as a graph can be specified into an entire STG, cluster STG, and element STG. The drawing shows the element STG about “annoyance”. There is the state of “annoyance” as the cause node, and the state of “stress and pressure” can be an adjoining node. The stress and pressure can proceed to a lack of care so as to escape the present element STG or branch into and proceed to “discomfort” node or “stress” node. The discomfort state can be influenced by anxiety and worry caused from the outside.

The discomfort and stress also can arrive at the result node of “lack of care” or “degrade of cognition power”. The lack of care state can be influenced by an interferer of concentration caused from the outside.

Referring to the time of maintaining the state of each node constituting such element STG and the delay time in proceeding to the next node, the various parameters of state transition can be measured and estimated.

Each node constituting the element STG of the present example is only an example, and the STG can be prepared by constituting the arbitrary cause node and arbitrary result node related to the xSHEL model of the annoyance.

In addition, the STG can be similarly constituted for the arbitrary items constituting the human element of the xSHEL model.

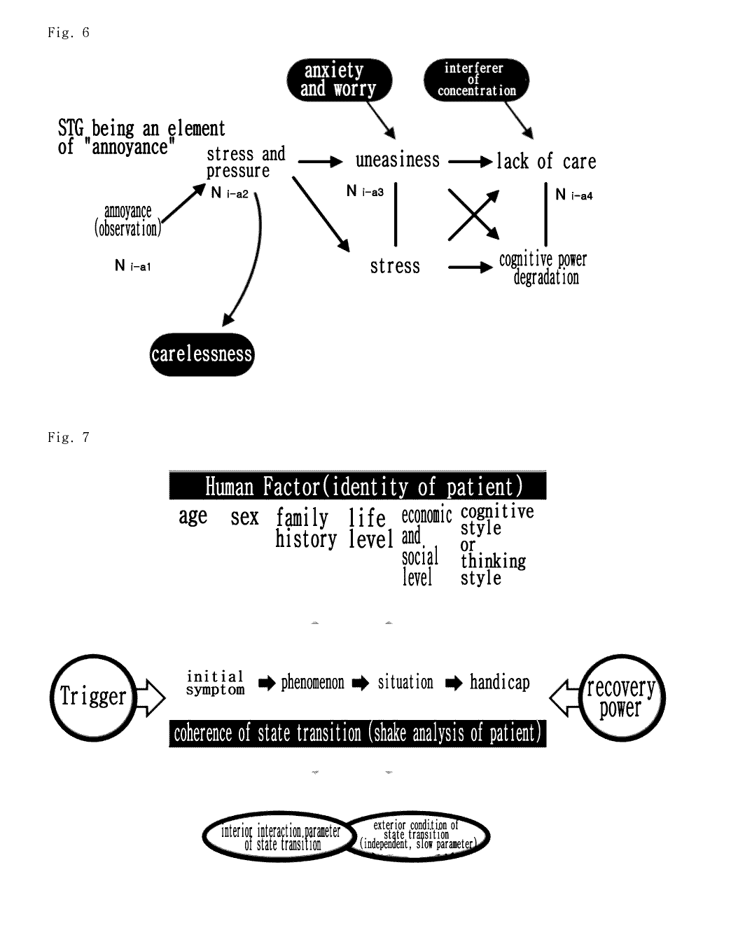

FIG. 7 is a drawing explaining a flow diagram for analyzing a process of the state transition by comparing and analyzing identity of patient and coherence of the state transition. The identity of the patient can be interpreted by being divided into the age, sex, family history, life type, economic level, social level, cognitive style (or thinking style), etc. The correlation of the state transition can be divided into four types of “initial symptom→phenomenon→situation→handicap”. The state proceeds from left to right by action of the trigger (catalyst), and the resilience proceeds from right to left.

The shake analysis of the patient according to the disturbance can be performed taking the process of state transition as a center, and here, the result of the process can be interpreted by the identity of the patient, interaction in the state transition and the external condition. This flow can be applied when specifying the units to which the disturbance will be introduced.

Here, the unit means a group (set) of adjoining elements or elements giving many influences to each other.

The cognitive style (or thinking style) establishes a self-destructive action pattern by coloring in view of one's point of view and adding his prejudice when observing any phenomenon. For example, the man who has a thinking style that any problem can never be solved would abandon the will of solution although he himself has the control. Such man needs the reinforcement of the resilience.

The trigger is a mechanism which acts as the catalyst (cause providing element) which makes the symptom to develop (intensify).

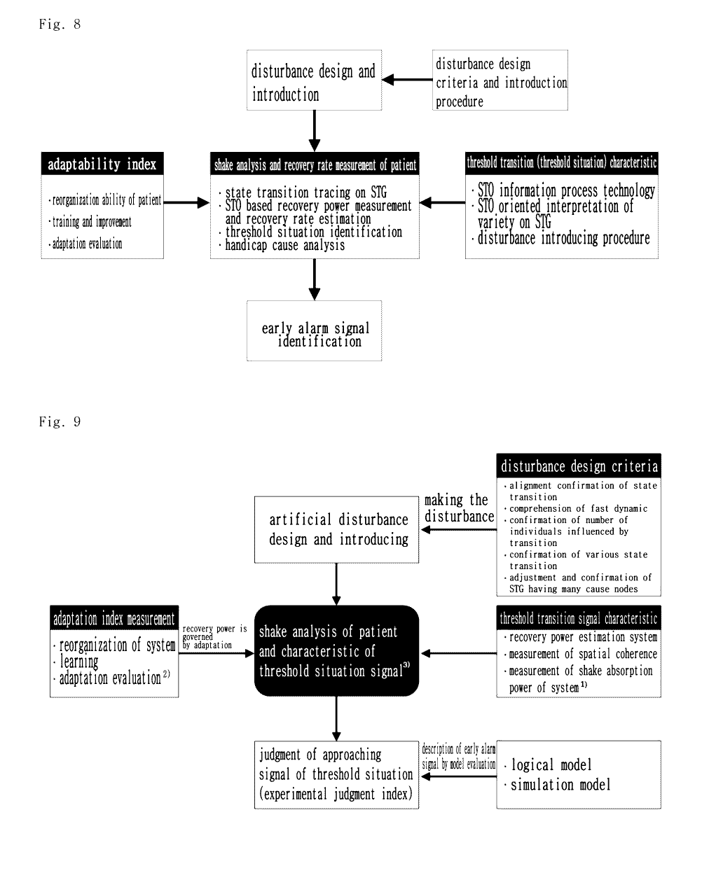

FIG. 8 is a flow diagram for explaining a process of identifying a threshold situation to identify an early alarm signal about handicap.

The identification of the threshold situation for the identification of the early alarm signal can be performed by introducing the designed disturbance according to a particular introducing method and thereafter analyzing the appearing shake state of the patient. That is, the early alarm signal can be identified by measuring the resilience rate of the shake state of the patient. The multimedia contents for training can be manufactured by analyzing the handicap cause based on the early alarm signal and by being based on the analyzed cause.

The shake analysis and the resilience rate measurement of the patient can trace the state transition on STG and refer to the resilience measurement based on the STO.

The identification of the threshold situation can be performed by using the information process technology of STO, interpreting the variety on the STG based on STO, and referring to the introducing procedure of the disturbance.

The adaptation power index can be measured based on the ability of reorganization of the patient, the improvement according to the training program, and the evaluation of the adaptation power.

FIG. 9 is a flow diagram for explaining a process of predicting a threshold situation in relation with the process of FIG. 8. The flow of the process of predicting the threshold situation can be performed by the method of analyzing the shake of the patient corresponding to the introduced disturbance, and judging the threshold situation approaching signal (early alarm signal) based on the characteristic of the threshold situation.

The design criteria of the disturbance is defined as a method of confirming the alignment of state transition, comprehending the fast dynamic, confirming the number of individuals which are influenced by the state transition, confirming the various state transitions, and confirming the adjustment of STO which has a lot of cause nodes.

If the disturbance is made according to the above criteria, the disturbance is introduced during the state transition process of the patient, the shake of the patient experiencing such disturbance is analyzed, and the foreboding signal related with the threshold situation is observed. The foreboding signal of the threshold situation is regarded to occur at the time of having observed the case of occurring the state transition where the similar partial STGs or cluster STGs are connected to each other, the case of showing a pattern where the duration of existence of arbitrary partial STGs or cluster STGs (the duration of maintaining the state of each node) is longer than the criteria, the case of showing the phenomenon of varying into the STO characteristic of adjoining node, the case of increasing the spatial coherence, and the case where the interrelation coefficient is higher than the criteria in the periodicity between the adjoining nodes, etc.

The characteristic of the threshold transition defines the system of estimation of the resilience, measurement of the spatial coherence, and measurement of the shake absorption power of the system, and can be used in analyzing the shake of the patient.

At this time, the shake absorption power means the resilience with which the patient recovers from the shake. The resilience determines the recovery speed or the size of the shake which the patient can endure without being transited to other state due to the shake. Since the resilience is difficult to measure in absolute value, it is evaluated in the relative point of view of how much the resilience is varied according to the variation of condition.

To analyze the shake of the patient, the adaptation index can be used. The measurement of the adaptation index can be performed through the evaluation of reorganization ability, the evaluation of learning ability, and the evaluation of adaptation power. Here, the adaptation power means the index representing the degree by which the patient reorganizes himself, learns, and adapts. That is, the adaptation power means the ability with which the system absorbs and reorganizes the shake to maintain the essentially same function, structure, identity, and feedback.

The judgment of the threshold situation approach signal by the shake analysis of the patient shall use the experimental judgment index. To this end, the theoretical model and/or the simulation model is necessary.

The embodiments of the present invention described above only exemplary show the technical thoughts of the present invention, and it should be appreciated that the scope of protection of the present invention should be interpreted according to the appended claims. In addition, it will be appreciated by those skilled in the art that various amendments and changes may be made in without departing from the essential characteristic and spirit of the present invention, and that all technical thoughts within the scope equivalent to the present invention should be interpreted to belong to the scope of rights of the present invention.

What is claimed is:

1. An apparatus for embodying state transition prediction and state improvement of liveware comprising:
an STTD construction and DB connection function section for providing to a patient a GQM (Goal Questionnaire Metrics) for diagnosing an arbitrary handicap symptom related to the liveware among human elements in xSHEL model, for deriving keyword related to the handicap symptom having occurred to the patient from response of the patient about the GQM, for judging the state about the handicap symptom having occurred to the patient by the keyword, for presenting a state transition where the state proceeds to next state to a state transition graph (STG) having a plurality of nodes (each node corresponds to the state about the handicap symptom), for transforming into a table by presenting each node of the STG as a spatial coordinate and STO data which is an attribute with which the state transition proceeds, and for interfacing the spatial coordinate and the STO data with a DB device;
a resilience level measurement section for measuring a resilience level of the patient by using the STO data;
a disturbance design/introduction and resilience rate estimation function section for designing a disturbance customized to the liveware of the patient, for applying the designed disturbance to the patient, and for estimating a resilience rate with which the patient adapts to the disturbance; and
an early alarm signal identification and training program providing function section for identifying an early alarm signal representing a threshold situation where the state transition of the patient rapidly changes to the handicap symptom, and for providing a training program for treating the progress of the state transition or a training program for reinforcing an adaptation power which can raise the resilience rate of the patient.

2. The apparatus of claim 1, wherein the handicap symptom is “melancholy” or “lack of care” included in “mental element” among the “liveware” of the “xSHEL” model obtained by enlarging trivial trigger data of “SHEL” model.

3. The apparatus of claim 1, wherein the STTD construction and DB connection function section comprises:
an STG construction module of ordered pairs comprising a graph presentation and table preparation function and a tracing function of state transition; and
a regulation construction module of state transition comprising an STO information process function and an interface function between STG and DB for constructing the regulation of state transition.

4. The apparatus of claim 1, wherein the resilience level measurement section comprises:
a required time measurement module of state transition between two units;
a state transition analysis module comprising a GQM analysis function for verification by specialist and a required time estimation function up to the threshold situation;
a transition direction search/displacement measurement/quantities estimation module;
a required time measurement and confirmation module comprising a required time measurement function, a stepwise variation level weight determination function, and a required time conformation reference establishment function; and
a resilience measurement algorithm providing module for providing an algorithm for measuring the resilience of the patient based on the STO.

5. The apparatus of claim 1, wherein the disturbance design/introduction and resilience rate estimation function section comprises:
a disturbance design module comprising an STO attribute adjustment function and a contents plan contents change function;
a disturbance design module by increase of variety of STO for designing the disturbance to be introduced to the patient;
a disturbance design module increasing the variety of trap decreasing the resilience;
a disturbance introducing method establishment module for adjusting the introducing method, strength and size, number of times and hour, speed and displacement direction, and quantities, to introduce the designed disturbance to a specific node during the state transition process of the patient;
a resilience rate estimation module comprising a disturbance introduction node, introducing method, disturbance size determination function, a function of selection of adjustment parameter of disturbance introduction STO and measurement of reorganization ability of patient, and a resilience rate estimation function; and
a resilience rate improvement and product analysis module comprising a node time centered improvement product analysis function and a improvement product analysis function by the comparison of state transition of node.

6. The apparatus of claim 1, wherein the early alarm signal identification and training program providing function section comprises:
a spatial correlation estimation module of time series material comprising a relation analysis function of environment factor and state transition process of patient, a time series spatial correlation estimation function connecting environment factor and state transition of patient, an equilibrium state maintenance judgment function, and a judgment function whether or not going to threshold situation;
a resilience rate comparison module of two units comprising a folding bifurcation signal observation function;
a disturbance introduction and early alarm signal identification module for identifying the early alarm signal according to the introducing of the disturbance; and
a resilience rate raising training program providing module comprising a training program providing function for reorganization power improvement for improving the resilience and adaptation power of the patient, a training program providing function for suppressing the noise in inducing the state transition to the separatix, a training program providing function for eliminating the handicap factor, and a meta cognition reinforcement training program providing function.

7. A method of state transition prediction and state improvement of liveware comprising:
(1) a step of providing to a patient a GQM (Goal Questionaire Metrics) for diagnosing an arbitrary handicap symptom related to the liveware among human elements in xSHEL model, deriving keyword related to the handicap symptom having occurred to the patient from response of the patient about the GQM, and judging the state about the handicap symptom having occurred to the patient by the keyword;
(2) a step of presenting a state transition where the state proceeds to next state to a state transition graph (STG) having a plurality of nodes (each node corresponds to the state about the handicap symptom), and transforming into a table by presenting each node of the STG as a spatial coordinate and STO data which is an attribute with which the state transition proceeds;
(3) a step of measuring a resilience level of the patient by using the STO data;
(4) a step of designing a disturbance customized to the liveware of the patient, applying the designed disturbance to the patient, and estimating a resilience rate with which the patient adapts to the disturbance; and
(5) a step of identifying an early alarm signal representing a threshold situation where the state transition of the patient rapidly changes to the handicap symptom, and providing a training program for treating the progress of the state transition or a training program for reinforcing an adaptation power which can raise the resilience rate of the patient.

8. The method of claim 7, wherein step (2) comprises:
a step of constructing an STG of ordered pairs by a graph presentation and table preparation function and a tracing function of state transition; and
a step of constructing a regulation of state transition by an STO information process function and an interface function between STG and DB for constructing the regulation of state transition.

9. The method of claim 7, wherein step (3) comprises:
a step of measuring a required time of state transition between two units;
a step of analyzing the state transition by a GQM analysis function for verification by specialist and a required time estimation function up to the threshold situation;
a step of searching a transition direction, measuring a displacement, and estimating quantities;
a step of measuring and confirming the required time by a required time measurement function, a stepwise variation level weight determination function, and a required time conformation reference establishment function; and
a step of providing an algorithm for measuring the resilience of the patient based on the STO.

10. The method of claim 7, wherein step (4) comprises:
a step of designing the disturbance by an STO attribute adjustment function and a contents plan contents change function;
a step of designing the disturbance by increase of variety of STO to design the disturbance to be introduced to the patient;
a step of designing the disturbance of increasing the variety of trap decreasing the resilience;
a step of adjusting the introducing method, strength and size, number of times and hour, speed and displacement direction, quantities, etc. to introduce the designed disturbance to a specific node during the state transition process of the patient;
a step of estimating the resilience rate by a disturbance introduction node, introducing method, disturbance size determination function, a function of selection of adjustment parameter of disturbance introduction STO and measurement of reorganization ability of patient, and a resilience rate estimation function; and
a step of analyzing the resilience rate improvement and product by a node time centered improvement product analysis function and an improvement product analysis function by the comparison of state transition of node.

11. The method of claim 7, wherein step (5) comprises:
a step of estimating the spatial correlation by a relation analysis function of environment factor and state transition process of patient, a time series spatial correlation estimation function connecting environment factor and state transition of patient, an equilibrium state maintenance judgment function, and a judgment function whether or not going to threshold situation;
a step of comparing the resilience rate of two units by a folding bifurcation signal observation function;
a step of introducing the disturbance and identifying the early alarm signal for identifying the early alarm signal according to the introducing of the disturbance; and
a step of providing a training program for raising the resilience rate of the patient by a training program providing function for reorganization power improvement for improving the resilience and adaptation power of the patient, a training program providing function for suppressing the noise in inducing the state transition to the separatix, a training program providing function for eliminating the handicap factor, and a meta cognition reinforcement training program providing function.
